(19) United States
(12) Patent Application Publication
(10) Pub. No.: US 2024/0162507 A1
(43) Pub. Date: May 16, 2024

(54) Traction Battery Having Internal Battery Pack Sensing Module

(71) Applicant: Ford Global Technologies, LLC, Dearborn, MI (US)

(72) Inventors: Daniel Paul Roberts, Livonia, MI (US); Francisco Fernandez-Galindo, Canton, MI (US); Liam E. West, Ferndale, MI (US); Mateusz Zadrozny, Macomb, MI (US)

(73) Assignee: Ford Global Technologies, LLC, Dearborn, MI (US)

(21) Appl. No.: 17/987,158

(22) Filed: Nov. 15, 2022

(51) Int. Cl. H01M 10/42

(52) U.S. Cl. CPC H01M 10/4257; H01M 2010/4271

(57) ABSTRACT

A battery, such as a traction battery for an electrified vehicle (EV), includes a battery sensor, such as a battery pack sensing module (BPSM), arranged internally within a housing of the battery. The battery further includes one or more battery cell arrays arranged within the housing. Each battery cell array including battery cells and a printed circuit board (PCB) electrically connected with voltage sense leads associated with the battery cells. The battery further includes a primary PCB arranged within the housing and electrically connected to the battery cell array PCBs. The battery sensor is electrically connected to the primary PCB to establish an electrical connection with the battery cell array PCBs whereby the battery sensor can sense the voltages of the battery cells.

### TECHNICAL FIELD

The present invention relates to a traction battery of an electrified vehicle.

### BACKGROUND

An electrified vehicle includes a traction battery for providing power to a motor of the vehicle to propel the vehicle. A sensor may be used to monitor the traction battery.

### SUMMARY

In embodiments, a battery, such as a traction battery for an electrified vehicle (EV), is provided. The battery includes a battery sensor, such as a battery pack sensing module (BPSM), arranged internally within a housing of the battery. The battery further includes one or more battery cell arrays arranged within the housing. Each battery cell array includes battery cells and a printed circuit board (PCB) electrically connected with voltage sense leads associated with the battery cells. The battery further includes a primary PCB arranged within the housing and electrically connected to the battery cell array PCBs. The battery sensor is electrically connected to the primary PCB to establish an electrical connection with the battery cell array PCBs whereby the battery sensor can sense the voltages of the battery cells. The battery sensor may be operable to wirelessly communicate sensed voltage information to a remote controller, such as a battery energy control module (BECM) of an electrified vehicle.

In embodiments, another battery is provided. The battery includes a housing and a cell array arranged within the housing. The cell array includes cells and a first PCB electrically connected with sense leads associated with the cells. The battery further includes a second PCB arranged within the housing and electrically connected to the first PCB. The battery further includes a battery sensor, such as a BPSM, arranged within the housing and electrically connected to the second PCB to establish an electrical connection with the first PCB.

The battery may further include a second cell array arranged within the housing, the second cell array including cells and a third PCB electrically connected with sense leads associated with the cells of the second cell array. In this case, the second PCB is electrically connected to the third PCB whereby an electrical connection is established between the battery sensor and the third PCB.

The battery sensor may be embodied as a PCB. Alternatively, the battery sensor PCB may be a rigid PCB and the first and second PCBs may be flexible PCBs.

The sense leads may be voltage sense leads whereby the battery sensor can sense voltages of the cells via the electrical connection established with the first PCB. The sense leads may be current sense leads whereby the battery sensor can sense currents of the cells via the electrical connection established with the first PCB. The sense leads may be temperature sense leads whereby the battery sensor can sense temperatures of the cells via the electrical connection established with the first PCB.

The second PCB may include a board-to-board connector mounted thereon. In this case, the battery sensor attaches with the board-to-board connector to be electrically connected to the second PCB.

The second PCB may include a standoff mounted thereon. In this case, the battery sensor attaches with the standoff to be spaced apart from the second PCB.

In embodiments, a battery pack sensing module (BPSM) is provided. The BPSM includes a rigid PCB configured to be carried by a battery PCB arranged within a housing of a battery. The BPSM further includes a connector connected to the rigid PCB and configured to mate with the battery PCB to establish an electrical connection with cell array PCBs, of cell arrays arranged within the housing of the battery, which are connected to the battery PCB.

In embodiments, a traction battery is provided. The fraction battery includes a housing, a first battery cell array arranged within the housing and including first battery cells and first sense leads associated with the first battery cells, and a second battery cell array arranged within the housing and including second battery cells and second sense leads associated with the second battery cells. The traction battery further includes a first PCB arranged within the housing and electrically connected with the first sense leads associated with the first battery cells and a second PCB arranged within the housing and electrically connected with the second sense leads associated with the second battery cells. The traction battery further includes a third PCB arranged within the housing and electrically connected to the first PCB and to the second PCB.

The third PCB may be operable to function as a BPSM. Alternatively, the traction battery may further include a BPSM arranged within the housing and electrically connected to the third PCB to establish an electrical connection with the first PCB and with the second PCB.

### BRIEF DESCRIPTION OF THE DRAWINGS

FIG. 1 illustrates a block diagram of an electrified vehicle (EV) having a traction battery;

FIG. 2 illustrates a block diagram of a traction battery assembly having the traction battery and a battery pack sensing module (BPSM), the BPSM being internally arranged within the traction battery, the traction battery comprising a plurality of battery cell arrays and a printed circuit board (PCB), and the battery cell arrays each including battery cells and a flexible PCB;

FIG. 3 illustrates a block diagram depicting communication flow of voltage signals of the battery cells of two of the battery cell arrays from the flexible PCBs of the two battery cell arrays to the PCB of the traction battery to the BPSM;

FIG. 4A illustrates a schematic diagram of the traction battery without the BPSM;

FIG. 4B illustrates a schematic diagram of the traction battery with the BPSM, the BPSM being connected to the PCB of the traction battery; and

FIG. 5 illustrates a components diagram of a board-to-board connector employed for connecting the BPSM to the PCB of the traction battery.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

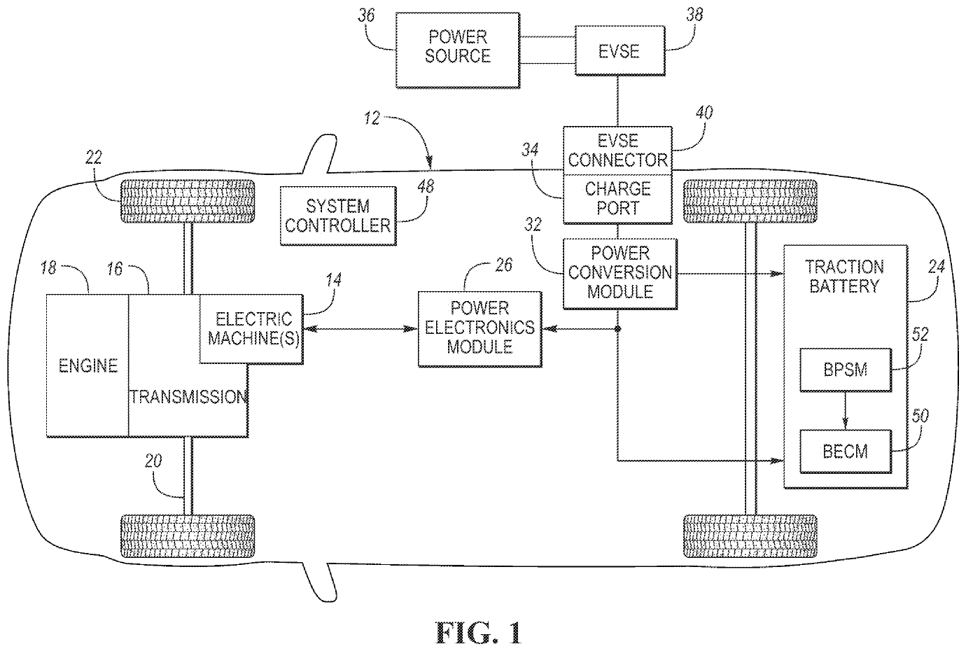

Referring now to FIG. 1, a block diagram of an electrified vehicle (EV) 12 is shown. EV 12 includes a powertrain having one or more traction motors (“electric machine(s)”) 14, a traction battery (“battery” or “battery pack”) 24, and a power electronics module 26 (e.g., an inverter). In this example, EV 12 is a hybrid electric vehicle (HEV). In a HEV configuration, EV 12 further includes an engine 18. In other examples, EV 12 is a battery electric vehicle (BEV). In a BEV configuration, EV 12 does not include engine 18.

Traction motor 14 is part of the traction powertrain of EV 12 for powering movement of the EV. In this regard, traction motor 14 is mechanically connected to a transmission 16 of EV 12. Transmission 16 is mechanically connected to a drive shaft 20 that is mechanically connected to wheels 22 of EV 12. Engine 18 is also mechanically connected to transmission 16 to provide propulsion capability to EV 12.

Traction motor 14 can provide propulsion capability to EV 12 while engine 18 is turned on or off. Traction motor 14 is capable of operating as a generator. Traction motor 14 acting as a generator can recover energy that may normally be lost as heat in a friction braking system of EV 12.

Traction battery 24 stores electrical energy that can be used by traction motor 14 for propelling EV 12. Traction battery 24 typically provides a high-voltage (HV) direct current (DC) output. Traction battery 24 may be a lithium-ion battery. Traction battery 24 is electrically connected to a power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In this example, EV 12 is a plug-in HEV (PHEV). As such, traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and EV 12. External power source 36 may provide DC or AC electric power to EVSE 38. EVSE 38 may have a charge connector 40 for plugging into a charge port 34 of EV 12.

A power conversion module 32 of EV 12, such as an on-board charger having a DC/DC converter, may condition power supplied from EVSE 38 to provide the proper voltage and current levels to traction battery 24. Power conversion module 32 may interface with EVSE 38 to coordinate the delivery of power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating EV 12. In embodiments, controller 48 is a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50 in communication with traction battery 24. BECM 50 is a traction battery controller operable for managing the charging and discharging of traction battery 24.

Traction battery 24 is comprised of a plurality of arrays of battery cells. Each array (“battery cell array” or “cell stack”) includes a group of the battery cells. The group of battery cells of a battery cell array are physically connected together to thereby form the battery cell array. BECM 50 may be operable to monitor array level characteristics of one or more of the battery cell arrays such as current, voltage, and temperature of the battery cell arrays.

A battery pack sensor module (BPSM) (or “battery sensor”) 52 is associated with traction battery 24. BPSM 52 is operable to monitor battery cell level characteristics of one or more battery cells of one or more of the battery cell arrays. For example, BPSM 52 may monitor terminal voltage, cell voltage, current, and temperature of the battery cells of one or more of the battery cell arrays.

Ordinarily, one BPSM is operable for monitoring battery cells of one battery cell array whereby a plurality of BPSMs are provided for a corresponding plurality of battery cell arrays. In accordance with the present disclosure, BPSM 52 (which is one BPSM) is operable for monitoring battery cells of multiple battery cell arrays.

BECM 50 and BPSM 52 are in communication with one another. BPSM 52 communicates the monitored battery cell level characteristics to BECM 50. BECM 50 may control the operation and performance of traction battery 24 based on the monitored battery cell level characteristics. For instance, BECM 50 may use the monitored battery cell level characteristics to detect a state of charge (SOC) of traction battery 24 for use in controlling EV 12 and/or the traction battery.

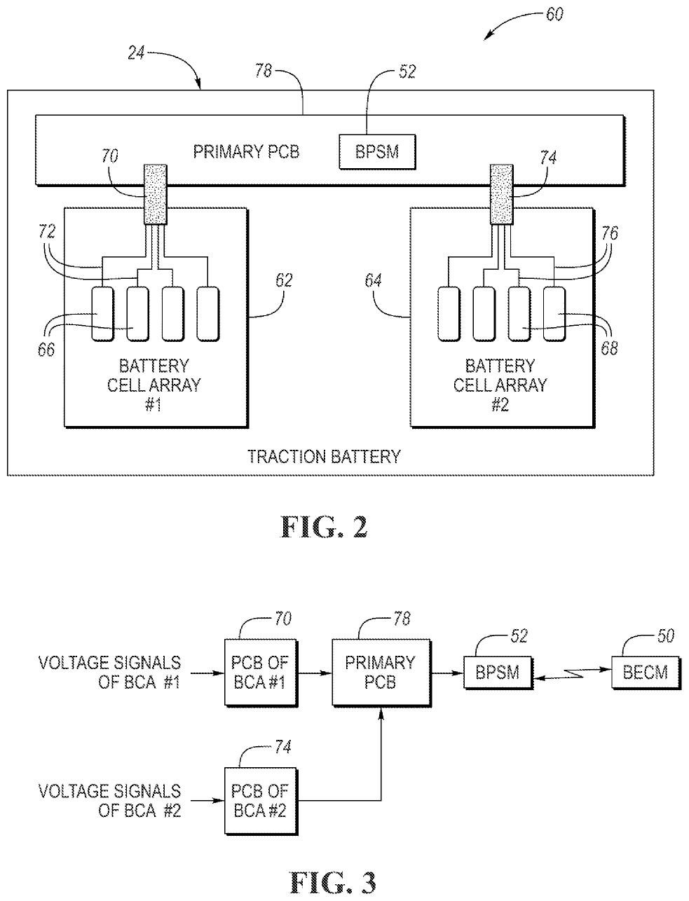

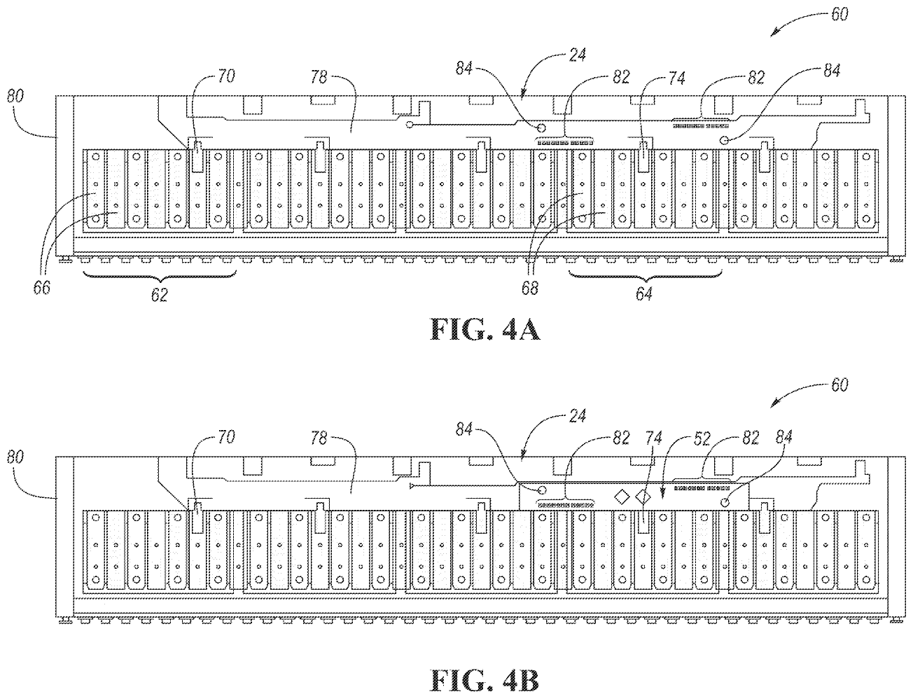

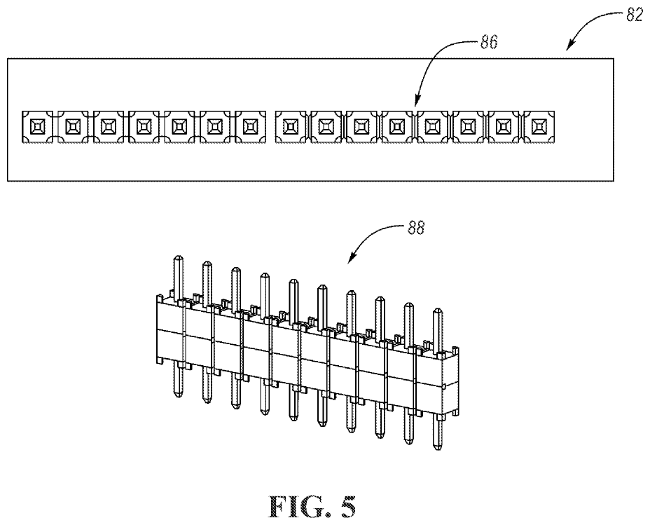

In accordance with the present disclosure, as shown in FIG. 1 and as described with reference to FIGS. 2 and 4B, BPSM 52 is arranged internally within traction battery 24. Further in accordance with the present disclosure as noted above, as described with reference to FIGS. 2 and 3, BPSM 52 is operable for monitoring battery cells of multiple battery cell arrays.

Referring now to FIG. 2, with continual reference to FIG. 1, a block diagram of a traction battery assembly 60 having traction battery 24 and BPSM 52 internally arranged within the traction battery is shown.

As described, traction battery 24 includes a plurality of arrays 62 of battery cells. For instance, as shown in FIG. 2, traction battery 24 comprises first and second battery cell arrays 62 and 64. Battery cell arrays 62 and 64 are arranged within the interior of traction battery 24, e.g., within a housing or a case of the traction battery. First battery cell array 62 includes battery cells 66. Second battery cell array 64 includes battery cells 68.

Each battery cell array further includes a printed circuit board (PCB) and a sense lead for each battery cell of the battery cell array. The PCB includes electrical componentry, integrated circuits, traces, etc. (not shown) for carrying out processing functions, communications functions, etc. associated with the battery cell array. The sense leads extend from the battery cells to the PCB. The sense leads may be voltage sense leads of the individual group of parallel battery cells, the terminals of the battery cell battery cell stack, temperature sensing thermistors, or electric current sensors. In this example, the sense leads are voltage sense leads. In other examples, the sense leads are temperature or electric current sense leads. Further in this example, the PCBs of the battery cell arrays are flexible PCBs.

First battery cell array 62 includes a first flexible PCB 70 and voltage sense leads 72. Voltage sense leads 72 extend between respective battery cells 66 and first flexible PCB 70. Voltage signals indicative of the voltages of battery cells 66 are communicated via respective voltage sense leads 72 to first flexible PCB 70. Likewise, second battery cell array 64 includes a second flexible PCB 74 and voltage sense leads 76. Voltage sense leads 76 extend between respective battery cells 68 and second flexible PCB 72. Voltage signals indicative of the voltages of battery cells 68 are communicated via respective voltage sense leads 76 to second flexible PCB 74.

Traction battery 24 further includes a primary PCB 78. Primary PCB 78 is also arranged within the interior of traction battery 24, e.g., within the housing of the traction battery, and spans the battery cell arrays, including battery cell arrays 62 and 64. Primary PCB 78 may be a rigid or flexible PCB. Primary PCB 78 includes electrical componentry, integrated circuits, traces, etc. (not shown) for carrying out processing functions, communications functions, etc. associated with primary PCB 78.

First and second flexible PCBs 70 and 74 of first and second battery cell arrays 62 and 64 are mechanically and electrically connected to primary PCB 78. The voltage signals of battery cells 66 of first battery cell array 62 may thereby be communicated from first flexible PCB 70 of the first battery cell array to primary PCB 78. Likewise, the voltage signals of battery cells 68 of second battery cell array 64 may thereby be communicated from second flexible PCB 74 of the second battery cell array to primary PCB 78.

As noted, in addition to traction battery 24, traction battery assembly 60 further includes BPSM 52. BPSM 52 is also arranged within the interior of traction battery 24, e.g., within the housing of the traction battery. BPSM 52 is embodied as a PCB or the like. BPSM 52 includes electrical componentry, integrated circuits, traces, etc. (not shown), for carrying out processing functions, communications functions, etc., associated with the BPSM.

BPSM 52 is mechanically and electrically connected to primary PCB 78 of traction battery 24. BPSM 52 may thereby receive from primary PCB 78 the voltage signals of battery cells 66 of first battery cell array 62 and the voltage signals of battery cells 68 of second battery cell array 64. For instance, the voltage signals of battery cells 66 are conveyed through a first set of traces (not shown) of primary PCB 78 extending from the connection between the primary PCB and first flexible PCB 70 to the connection between the primary PCB and BPSM 52. Likewise, the voltage signals of battery cells 68 are conveyed through a second set of traces (not shown) of primary PCB 78 extending from the connection between the primary PCB and second flexible PCB 74 to the connection between the primary PCB and BPSM 52.

Referring now to FIG. 3, with continual reference to FIGS. 1 and 2, a block diagram depicting communication flow of voltage signals of battery cells 66 and 68 of first and second battery cell arrays 62 and 64 from first and second flexible PCBs 70 and 74 of the first and second battery cell arrays to primary PCB 78 of traction battery 24 to BPSM 52 is shown.

BPSM 52 and BECM 50 are operable to wirelessly communicate with one another. BPSM 52 may thereby wirelessly communicate the voltage signals of first and second battery cell arrays 62 and 64 to BECM 50 whereby BPSM 52 communicates monitored battery cell level characteristics to BECM 50.

Referring now to FIG. 4A, with continual reference to FIGS. 1 and 2, a schematic diagram of traction battery 24 without BPSM 52 is shown. As shown in FIG. 4A, battery cell arrays, including first and second battery cell arrays 62 and 64, and primary PCB 78 are internally arranged within a housing 80 of traction battery 24; and the flexible PCBs of the battery cell arrays, including flexible PCBs 70 and 74 of first and second battery cell arrays 62 and 64, are mechanically and electrically connected to primary PCB 78.

As further shown in FIG. 4A, in this example, primary PCB 78 includes at least one board-to-board connector 82 and at least standoff 84 thereon. In this example, primary PCB 78 includes two connectors 82 (illustrated in further detail in FIG. 5) and two standoffs 84.

Connectors 82 are employed for enabling another PCB, such as in the form of BPSM 52, to be mechanically and electrically connected to primary PCB 78. Connectors 82 include a plurality of connection points which connect to the traces of primary PCB 78 when the connectors 82 are mounted onto the primary PCB 78. In this way, the voltage signals of the battery cells can be communicated from primary PCB 78 to BPSM 52 via connectors 82.

Standoffs 84 are heat-staked onto primary PCB 78. Standoffs 84 are used to attach the other PCB, such as in the form of BPSM 52, to primary PCB 78 while elevating the other PCB from the primary PCB 78. In this way, when BPSM 52 is mechanically and electrically connected to primary PCB 78 via connectors 82, standoffs 84 maintain vertical spacing between the BPSM and the primary PCB.

Referring now to FIG. 4B, with continual reference to FIGS. 1, 2, and 4A, a schematic diagram of traction battery 24 with BPSM 52 is shown. As shown in FIG. 4B, BPSM 52 is internally arranged within housing 80 of traction battery 24 and is connected, via connectors 82, to primary PCB 78 of the traction battery.

FIG. 5 illustrates a components diagram of a board-to-board connector 82. As described, connector 82 is employed for connecting BPSM 52 to primary PCB 78 of traction battery 24 so that the voltage signals and the like can be communicated from the primary PCB to the BPSM. As shown in FIG. 5, the components of connector 82 include a female receptacle unit 86 and a male spacer connector unit 88. Receptacle unit 86 includes a plurality of receptacles for receiving solder pins and mounts to primary PCB 78. The receptacles of receptacle unit are electrically connected to traces of primary PCB 78 while receptacle unit 86 is mounted to the primary PCB. Spacer connector unit 88 includes a plurality of solder pins and mounts to receptacle unit 86 whereby the solder pins at one end are respectively received within the receptacles of the receptacle unit. The solder pins at the other end are respectively soldered to respective connection points of the PCB of BPSM 52 whereby the BPSM is connected to primary PCB 78 as described herein. Spacer connector unit 88 thereby embodies a standoff for cooling effect.

As described, traction battery assembly 60 in accordance with the present disclosure includes a traction battery 24 and a BPSM 52 internally arranged within the traction battery. BPSM 52 embodies a relatively small PCB that is directly connected to the battery array (i.e., primary PCB 78) using one or more non-removable joints. BPSM 52 monitors and controls the cell voltages and thermistors in the same manner as typical BPSMs. The PCB of BPSM 52 is a generic PCB and can include a plurality of pins, pads, etc. for electrical connection to the array sense leads (i.e., via the connection between BPSM 52 and primary PCB 78 and the connections between primary PCB 78 and the flexible PCBs of the battery cell arrays).

For assembly, BPSM 52 may be supplied directly to a battery array supplier to be attached to a traction battery having a layout according to design specifications of the supplier. BPSM 52 is then attached (e.g., solder, laser, etc.) to the battery array with the rest of sense lead components, such as fuses and thermistors. The standoffs provide structural support and retention prior to the soldering process. The generic PCB of BPSM 52 can potentially allow a common design to be used in multiple battery array variants.

Advantages of traction battery assembly 60 having a traction battery 24 and a BPSM 52 internally arranged within the traction battery in accordance with the present disclosure include standoffs between primary PCB 78 and the PCB of the BPSM allowing space for convective current flow. Full integration of BPSM 52 in the battery array allows more efficient use of space on the vehicle. Further, the number of parties involved in design collaboration may be reduced (a BPSM designer designs the BPSM; and a battery array assembler packages the BPSM to the traction battery), which should increase the agility and speed of development. Testing can be completed individually at the component level. More effective trace routing can be achieved, as the BPSM PCB is stacked over the sense leads, whereby increased flexibility of battery array traces to BPSM PCB layout is achievable. High reliability is provided due to off the shelf components and traditional through-hole soldering process.

As described, the present disclosure provides a generic BPSM design for integrated array applications as an alternative to external BPSM designs. Per the generic BPSM design, a BPSM is internal to a traction battery. The BPSM has a PCB directly soldered to pins associated with voltage sensor traces of the traction battery, which eliminates the connectors that are usually necessary when connecting a BPSM external to the traction battery to the pins.

In other embodiments, the functionality of the BPSM may be incorporated by the primary PCB. As such, in these embodiments, the separate BPSM PCB is dispensed with and instead the primary PCB functions as the BPSM in addition to its existing functions.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A battery comprising:
a housing;
a cell array arranged within the housing, the cell array including cells and a first printed circuit board (PCB) electrically connected with sense leads associated with the cells;
a second PCB arranged within the housing and electrically connected to the first PCB; and
a battery sensor arranged within the housing and electrically connected to the second PCB to establish an electrical connection with the first PCB.

2. The battery of claim 1 further comprising:
a second cell array arranged within the housing, the second cell array including cells and a third PCB electrically connected with sense leads associated with the cells of the second cell array; and
wherein the second PCB is electrically connected to the third PCB whereby an electrical connection is established between the battery sensor and the third PCB.

3. The battery of claim 1 wherein:
the battery sensor is embodied as a third PCB.

4. The battery of claim 3 wherein:
the second PCB includes a board-to-board connector mounted thereon; and
the third PCB attaches with the board-to-board connector to be electrically connected to the second PCB.

5. The battery of claim 3 wherein:
the second PCB includes a standoff mounted thereon; and
the third PCB attaches with the standoff to be spaced apart from the second PCB.

6. The battery of claim 3 wherein:
the third PCB is a rigid PCB.

7. The battery of claim 1 wherein:
the first PCB is a flexible PCB.

8. The battery of claim 1 wherein:
the second PCB is a flexible PCB.

9. The battery of claim 1 wherein:
the sense leads are voltage sense leads.

10. The battery of claim 1 wherein:
the sense leads are current sense leads.

11. The battery of claim 1 wherein:
the sense leads are temperature sense leads.

12. A battery pack sensing module comprising:
a rigid printed circuit board (PCB) configured to be carried by a battery PCB arranged within a housing of a battery; and
a connector connected to the rigid PCB and configured to mate with the battery PCB to establish an electrical connection with cell array PCBs, of cell arrays arranged within the housing of the battery, which are connected to the battery PCB.

13. The battery pack sensing module of claim 12 wherein:
the rigid PCB is operable to wirelessly communicate with a remote controller.

14. A traction battery comprising:
a housing;
a first battery cell array arranged within the housing and including first battery cells and first sense leads associated with the first battery cells;
a second battery cell array arranged within the housing and including second battery cells and second sense leads associated with the second battery cells;
a first printed circuit board (PCB) arranged within the housing and electrically connected with the first sense leads associated with the first battery cells;
a second PCB arranged within the housing and electrically connected with the second sense leads associated with the second battery cells; and
a third PCB arranged within the housing and electrically connected to the first PCB and to the second PCB.

15. The traction battery of claim 14 wherein:
the third PCB is operable to function as a battery pack sensing module (BPSM).

16. The traction battery of claim 14 further comprising:
a battery pack sensing module (BPSM) arranged within the housing and electrically connected to the third PCB to establish an electrical connection with the first PCB and with the second PCB.

17. The traction battery of claim 14 wherein:
the first PCB and the second PCB are flexible PCBs.

18. The traction battery of claim 14 wherein:
the third PCB is a flexible PCB.
